(19) United States
(12) Patent Application Publication
(10) Pub. No.: US 2026/0014876 A1
(43) Pub. Date: Jan. 15, 2026

(54) CONTACT WIRE LUBRICATION DEVICE

(71) Applicant: Maximilian SIMCHEN, Dresden (DE)

(72) Inventor: Maximilian SIMCHEN, Dresden (DE)

(21) Appl. No.: 19/333,524

(22) Filed: Sep. 19, 2025

Related U.S. Application Data
(63) Continuation of application No. PCT/EP2024/058565, filed on Mar. 28, 2024.

(30) Foreign Application Priority Data
Mar. 28, 2023 (DE) 10 2023 107 808.9

(51) Int. Cl. B60L 5/02; B60L 5/06

(52) U.S. Cl. CPC B60L 5/02; B60L 5/06; B60L 2200/18; B60L 2200/26

(57) ABSTRACT

A device applies flowable antifreeze to a contact wire of an overhead line, from which an electrically driven vehicle draws off electrical energy via a current collector. The device includes: a holder extending from the vehicle in a direction of the contact wire; a transfer roller, oriented horizontally and transversely with respect to a vehicle longitudinal axis, axially-rotatably coupled to the holder, and capable of contact with the contact wire; and an open container for the antifreeze below the transfer roller and partially enclosing a circumferential surface of the transfer roller so that the transfer roller wettable with the antifreeze supplied via the container via a rotational movement. The device controls the rotational movement configured to limit a circumferential speed of the transfer roller so that the transfer roller rotates more slowly than in a case of sliding-free rolling along the contact wire.

### CROSS REFERENCE TO RELATED APPLICATIONS

This application is a continuation of International Application No. PCT/EP2024/058565 (WO 2024/200697 A1), filed on Mar. 28, 2024, and claims benefit to German Patent Application No. DE 10 2023 107 808.9, filed on Mar. 28, 2023. The aforementioned applications are hereby incorporated by reference herein.

### FIELD

The present disclosure relates to a device for applying lubricant or antifreeze to a contact wire of an overhead line, from which an electrically driven vehicle draws off electrical energy by means of a current collector. Furthermore, the present disclosure relates to a device which is suitable in particular for de-icing, i.e. for preventive antifreeze of a contact wire, wherein the operation of the device is not limited to a maximum vehicle speed.

### BACKGROUND

Overhead line contact wires are generally known for the provision of electrical energy (current). Such contact wires are used, for example, for rail vehicles such as trams or express trains, but also overhead line buses (O-buses), in order to supply the vehicles with the required electrical energy during travel. As shown in FIGS. 1 and 2 using the example of a tram, the contact wire is usually tensioned above the rails (or road), in order to represent a pole of the voltage source, from which the vehicle (for example tram) is supplied with the required energy via a current collector (for example with a contact bar or strip). The contact wire is normally composed of copper and usually has a circular cross section, in which two V-shaped grooves are formed on the upper half, in such a way that holding clamps can engage there (see FIG. 2).

During the winter months, icing can frequently occur on the contact wires and thereby cause unwanted interruptions in contact. These can in turn lead to damage to vehicle components, to tear down of the vehicle or to the vehicle coming to a standstill. If, for example, an exit track is thereby blocked during the disengagement time, considerable delays or even outages can occur. In addition, the frequent occurrence of arcs results in increased wear on the contact strip and contact wire.

Consequently, before the onset of temperatures below the freezing point, the contact wire (or contact line) is started to be “lubricated” or wetted with an antifreeze, such as, for example, glycerol. This is usually done by means of a felt roll lubricating bar which is mounted on an operating vehicle (according to BOStrab a maintenance vehicle used for the maintenance of operating facilities) or else on a vehicle for passenger transport (such as, for example, tram, express train, O-bus). Depending on the size of the route network and the number of lubricating vehicles, the lubricating journeys are carried out in three layers for up to twenty-four hours a day. In this case, a felt roll which is constantly impregnated with the antifreeze (for example glycerol) by a supply hose rolls over the contact wire. Such a felt roll construction is described in more detail, for example, in DE 20 2004 008 632 U1. Here, the felt roll is fitted on a converted current collector which, in addition to the traction current collector, is mounted on the vehicle roof. In practice, however, the present inventor has recognized a problem is that excess lubricant (glycerol) simply drips into the collecting trough and is conducted into the vehicle, wherein the lubricant cannot be reused since it is contaminated to a great extent, inter alia, with water, carbon abrasion, fiber abrasion and/or dirt from the environment (for example foliage).

In addition, the roll which is pressed on during travel rolls directly, i.e. the circumferential speed of the roll corresponds to the travel speed, over the contact with the contact wire, with the result that the rotating inertial forces which occur at relatively high speeds in the mechanical system and the resultant risk of the lubricant being thrown off limit the permitted maximum speed of the vehicle to approximately 30 km/h. The fiber abrasion, which is also unavoidable, can lead, together with the contamination from the contact wire and carbon abrasive strips, to considerable blockages in the return, with the result that failures or damage can occur repeatedly. The maintenance and cost outlay for such a device is therefore relatively high.

Furthermore, the customary devices require a minimum pressing force (for example approximately 85 newtons) between the felt roll and the contact wire in order to ensure that the felt roll is carried along. Together with the pressing force of the traction current collector, the device can therefore bring about a high loading and deflection of the contact wire. This increases the probability of collision with further contact line elements, wherein, in the worst case, the total loss of the lubrication bow and a tearing of the contact line occur.

For the case where the felt roll is blocked (for example by means of a heavy-running bearing or even a relatively small reduction in the pressing force, which occurs when the outlet is clogged by felt abrasion and the trough is running full), it is destroyed in a very short time and must therefore be renewed. In order to prevent this, electronic rotation monitoring has hitherto been necessary for this purpose.

In addition, the present inventor has recognized that the impregnation behavior of the felt roll, the spinning off of lubricant and the run-off behavior of the contaminated and highly viscous residual lubricant can cause considerable fluctuations in the system weight and the already sensitive pressing force. An uneven impregnation of the felt roll can cause, for example, a strong imbalance and vibrations resulting therefrom on the bow and contact line.

Accordingly, the relatively high system weight of the felt roll applicator loads the bow frame and can cause high inertia forces, which in turn necessitates a “reinforced” bow frame (more powerful lifting spring).

The high mass also ensures a low natural frequency of the projecting assembly, with the result that it can be excited particularly easily by accelerations from the vehicle dynamics or imbalance of the roll, even at low speeds.

Alternative means for de-icing a contact wire often comprise complex devices, such as, for example, the device in DE 10 2011 054 610 A1, where the instantaneous position of the contact wire is determined by means of sensors, in order then to wet or spray the close-by contact wire with antifreeze via suitable supply outlets.

The present inventor recognized a further problem which occurs as a result of the use of conventional lubricating rolls, such as, for example, cylindrical felt rolls, is that the roll often has to run over intersecting contact wires in the event of changes in the direction of the vehicle or crossing a different route, that is to say the roll is guided in a sliding manner from a contact wire running on a first vertical plane to a contact wire running in a different direction and on a different vertical plane. The contact strip of the traction current collector is accordingly equipped with a suitable profile, with the result that the contact strip can simply transition in a sliding manner from one contact wire to the other contact wire without becoming entangled with contact wires on different vertical planes. By contrast, when a conventional (cylindrical) lubricating roll is used, the vehicle usually has to stop before the contact wire intersection, with the result that the lubricating roll can be lowered and the vehicle can be driven in the direction of the second contact wire, where the lubricating roll is then brought into contact with the contact wire again. A transition-free sliding from one contact wire to the other is not possible without problems as a result of the straight profile of the lubricating roll (that is to say without wear and with the exclusion of damage to the lubrication bow and contact line system).

### SUMMARY

In an embodiment, the present disclosure provides a device that applies flowable antifreeze to a contact wire of an overhead line, from which an electrically driven vehicle draws off electrical energy via a current collector. The device includes: a holder, which extends from the vehicle in a direction of the contact wire; a transfer roller, which: is oriented horizontally and transversely with respect to a vehicle longitudinal axis, is coupled to the holder in an axially rotatable manner, and is configured to be brought into contact with the contact wire; and an open container for the antifreeze arranged below the transfer roller and partially enclosing a circumferential surface of the transfer roller in such a way that the transfer roller is configured to be wetted with the antifreeze supplied via the container via a rotational movement. The device is configured for controlling the rotational movement configured to limit a circumferential speed of the transfer roller to an effect that the transfer roller rotates more slowly than in a case of sliding-free rolling along the contact wire.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a rail vehicle (tram) which draws off electrical energy from the contact wire via a current collector with a contact strip;

FIG. 2 shows a perspective view of a customary current collector, which is mounted on the vehicle roof and is brought into contact with the contact wire, and a perspective partial view of a grooved contact wire;

FIGS. 3A-3B show a sectional view of the lubrication device of the present disclosure along a transverse plane and making contact with the contact wire in a rolling-sliding manner, and a partial section along a frontal plane;

FIG. 4A shows a frontal view of a contact strip of a customary current collector, and FIG. 4B shows a partially sectional frontal view of the lubrication roller device of the present disclosure;

FIG. 5A shows the container without the transfer roller, FIGS. 5B-5C show sectional frontal views of the container filled with antifreeze without inclination or transverse acceleration by the vehicle, and with lubricant level displaced by inclination or transverse acceleration;

FIG. 6 shows a schematic illustration of the antifreeze supply via separate storage and collection containers, and

FIG. 7A shows an illustration of an alternative antifreeze supply via a feed unit which brings about a contamination-free return and a storage container, and FIG. 7B shows a sectional illustration of the feed unit.

### DETAILED DESCRIPTION

Aspects of the present disclosure improve a contact wire de-icing system in such a way that it is a construction which is as simple as possible, more durable and therefore more reliable, in order to avoid or at least minimize customary wear damage. Furthermore, the contact wire de-icing system is to be improved in such a way that required contact pressure forces are reduced and vehicle maximum speeds are maximized. Furthermore, at least one embodiment provides an improved contact wire de-icing system that enables the lubricating roll, just like the contact strip for current transmission, to slide from one contact wire to the other contact wire without interruption in the event of changes in direction of the vehicle.

According to one embodiment of the present disclosure, a device is provided for applying flowable antifreeze to a contact wire of an overhead line, from which an electrically driven vehicle draws off electrical energy by means of a current collector. The device comprises in each case a holding device (also referred to herein as a holder) which extends from the vehicle in the direction of the contact wire; a transfer roller which is oriented horizontally and transversely with respect to the vehicle longitudinal axis, is coupled to the holding device in an axially rotatable manner, and can be brought into contact with the contact wire, and an open container for the antifreeze which is arranged below the transfer roller and partially enclosing a circumferential surface of the transfer roller in such a way that the transfer roller can be wetted with the antifreeze supplied via the container by means of a rotational movement, characterized in that the device also has means for controlling the rotational movement configured to limit a circumferential speed of the transfer roller to the effect that the transfer roller rotates more slowly than in the case of sliding-free rolling along the contact wire.

Because the device is designed with the above means for controlling the rotational movement and the transfer roller can slide along the contact wire, the vehicle does not have to reduce the travel speed since the transfer roller can always run at the desired rotational speed (actively or passively) by the means for controlling the rotational movement. As a result, the amount of lubricant transported is also optimally regulated and the system can be designed in such a way that it can always be operated with the smallest possible contact pressure forces.

It is advantageous if a material of the transfer roller is optimized tribologically with the contact wire in such a way that the contact wire and the transfer roller which moves relative to the contact wire interact in a rolling-sliding manner within a predetermined contact pressure range, wherein the material is in particular a plastic, a plastic with a base matrix composed of fluorine-stabilized plastic which is filled with a solid lubricant, or a metallic material with good sliding properties, in particular brass, or a metal with an abrasion-resistant coating or an applied sliding lacquer, in particular aluminium with a nikasil coating.

As a result of the tribologically optimized smooth material, substantially wear-free rolling-sliding interaction between the transfer roller and the contact wire is brought about, with the result that the circumferential speed of the transfer roller does not depend directly on the vehicle speed as in the case of the felt roll and therefore, in principle, no speed limitation of the vehicle is required. This means that the transfer roller can rotate at a predetermined circumferential speed independently of the vehicle speed, in order, for example, to avoid centrifugal-force-induced spinning off and without substantially increasing the wear between the transfer roller and the contact wire.

The means for controlling the circumferential speed of the transfer roller can vary the circumferential speed, for example, by varying the contact pressure between the transfer roller and the contact wire if the roller rotational speed is not predefined by means of a motor but is limited by a passively acting braking device.

Advantageously, the material of the transfer roller is a plastic which contains at least one solid lubricant. In a preferred implementation, the solid lubricant comprises one or more of the following substances, such as, for example, graphite, MoS2, PTFE, synthetic metal sulfides. The transfer roller can therefore be coupled in the simplest manner to the holder so as to be able to run via a lubricant-free plain bearing.

Furthermore, the transfer roller can be produced as a hollow roller composed of a metallic material with good sliding properties, such as, for example, brass, certain cast types or with a particularly abrasion-resistant coating (for example aluminium with a nikasil coating, known from motor engineering) or with applied sliding lacquers.

In a preferred implementation, the circumferential surface of the transfer roller is of substantially convexly spherical design. As a result, the contour of the transfer roller is adapted to the conventional contact strip, and the adapted, that is to say convexly spherical, contour of the transfer roller permits a sliding from one contact wire to another contact wire without problems (for example in the event of changes in direction) or the traveling over a transversely intersecting contact wire without becoming entangled or entangled in the process.

It is furthermore advantageous if the holding device comprises, as means for controlling the circumferential speed of the transfer roller, a pretensioning device (also referred to herein as a pretensioner) for providing the predetermined contact pressure between the contact wire and the transfer roller. As a result, the contact pressure between the contact wire and the transfer roller can be varied selectively via the pretensioning device. In particular, the means for controlling the circumferential speed control the circumferential speed of the transfer roller in such a way that the contact pressure is reduced for high travel speeds, with the result that the transfer roller rotates more slowly than in the case of sliding-free rolling along the contact wire, in order thus to prevent the antifreeze from being spun off at high travel speeds.

As an alternative or in addition to the variability of the contact pressure, it is conceivable for the contact pressure between the contact wire and the transfer roller to be variable proportionally to the speed of the vehicle via the pretensioning device. Here, it is possible to use means which are suitable for this purpose and which can regulate the contact pressure as a function of the vehicle speed (for example via a control unit or lift or output forces caused by the relative wind). It is furthermore conceivable for the pretensioning device to comprise a spring system. The spring system can be a simple spring system or an actively controllable spring system. As an alternative, the contact pressure can also be varied via a pretensioning device with at least one controllable actuator. For this purpose, for example, electrical or pneumatic or else hydraulic actuators can be used.

In a preferred implementation, the holding device comprises a rigidly coupled holding element which forms a plain bearing with the transfer roller. As a result of the use of a tribologically advantageous plastic with embedded solid lubricant, self-lubrication of the sliding surface between the fixed holding element and the rotatable transfer roller is ensured. In a first advantageous embodiment, the holding element is a shaft, and in particular a hollow shaft. In a further advantageous embodiment, the holding element comprises two axially arranged bearing journals. The embodiments enable a lightweight construction with minimal wear since, on the one hand, separate bearing components are dispensed with and, on the other hand, the inertia forces (for example from fluctuating contact wire height or from the vehicle dynamics of the vehicle) are kept relatively constant and at a minimum.

The container of the device according to an implementation of the present disclosure preferably has at least one inlet, which is arranged at one axial end, for feeding, and an outlet, which is arranged centered between the mutually opposite axial ends on a side wall of the container, for discharging the antifreeze. It has furthermore proven to be particularly advantageous if the container comprises two inlets which are attached to the mutually opposite axial ends of the container. It is furthermore advantageous if the at least one inlet forms a fluid circuit with the outlet and antifreeze flows continuously through the container.

The laterally attached inlets and the centrally positioned outlet accordingly permit a continuous flow which transports antifreeze from the probably less soiled outer sides (rarer contact wire contact) to the probably more heavily soiled center of the transfer roller (more frequent contact wire contact). This ensures that sufficient “fresh” antifreeze is always available for wetting the transfer roller and the contaminated portions are consumed first. The inlets are also hydraulically balanced in order to achieve the same throughflow on both sides.

In a preferred implementation, the outlet is attached at a predetermined distance from the container base, wherein the outlet is spaced further apart from the container base than the at least one inlet. The predetermined distance of the outlet from the container base firstly determines the level of the antifreeze, but also ensures, by virtue of its central position close to the area center of gravity of the liquid level, that no change in the filling quantity occurs in the event of transverse accelerations or inclination of the container (e.g. stopping in an elevated position of the track, or centrifugal forces in the event of a change in direction), which in turn keeps the system weight and the contact force required therefrom between the contact wire and the transfer roller constant during travel. Furthermore, the free flow path of a respective antifreeze flow is only half the roller length (applicator), as a result of which the level difference which occurs on account of the relatively high viscosity of the fluid (for example glycerol) is also halved.

In a preferred implementation, the circumferential speed and/or the circumferential direction of the transfer roller can be regulated or controlled independently of the vehicle speed. In an advantageous embodiment, the circumferential speed and/or the circumferential direction of the transfer roller is controlled or controlled via a motor coupled to the transfer roller. In another, alternative embodiment, the circumferential speed of the transfer roller is controlled or controlled via a brake coupled to the transfer roller. Here, the brake can be a simple friction brake, a centrifugal brake or a viscous brake, but also an electrodynamic brake, for example generator brake or eddy-current brake (advantageous because it can be adjusted precisely and independently of temperature), wherein the brake can be actuated, for example, via a generator coupled to the transfer roller.

As an alternative or in addition, the lubricant filling in the trough can be used as a viscous brake, wherein the adjustment of the conveying rotation is achieved by changing the pressing force on the contact wire and/or the increase/decrease in the level in the trough (overflow position or level sensor).

As a result, the circumferential speed of the transfer roller can either be kept constant actively via a motor or can be regulated to a maximum passively via a brake, the motor or the brake therefore in each case representing means for controlling the rotational movement of the transfer roller. The rotational speed and the sliding are forced by the forced drive or the braking device, to be precise even if the tribo system between roller and contact wire is disturbed, for whatever reason, that is to say for example that the coefficient of friction or the pressing force has changed as a result of external influences. As a result, although the wear can increase, operational reliability and functional reliability are nevertheless provided at any time. Particularly dangerous vibrations caused by uncontrolled imbalance can accordingly not occur.

Furthermore, the circumferential direction can be determined actively via a motor. The amount of antifreeze conveyed by the transfer roller can therefore be set to a desired extent via the rotational speed, the circumferential speed or the circumferential direction of the transfer roller. Furthermore, the reliable entrainment of the transfer roller by the contact wire is no longer required and also not desired. As a result, the transfer roller can always be driven with the smallest possible contact pressure forces (that is to say as small as possible in order to achieve a rolling-sliding interaction between the contact wire and the tribologically optimally adapted transfer roller), which in turn substantially reduces the transfer roller wear and the contact wire deflection and loading.

The terms “lubricant”, “antifreeze”, “glycerol”, “deicing agent or medium” are to be understood synonymously in the following description. The terms “container” and “trough” are to be understood synonymously in the following description and describe the vessel which faces the transfer roller and is supplied with lubricant.

Specific terms such as “right”, “left”, “top”, “bottom”, “front”, “rear”, “high” and “low” denote directions in the appended figures with respect to the respective component, device or device when mounted in an operationally capable manner. The terms “inside” and “outside” denote directions with respect to a geometric central axis or center of a respectively described component, device or device, wherein the meaning is evident from the description.

Furthermore, the terms “connected”, “attached”, “coupled”, “mounted” respectively describe direct connections between two links or components, i.e. without an intermediate link, but also indirect connections between links or components, i.e. with at least one intermediate link.

Furthermore, unless specified otherwise, the use of ordinal adjectives such as e.g. “first”, “second”, “third”, etc. merely shows different instances of identical objects and does not mean that these objects have to be in a specific order, either temporally, spatially or in a specific ranking order.

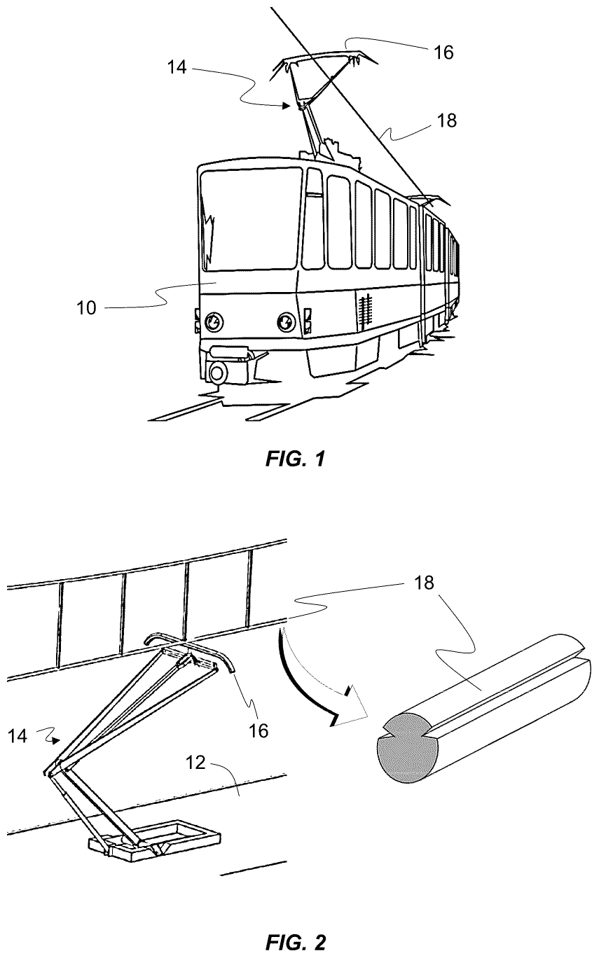

With reference to FIGS. 1, 2 and 3A-3B, the lubricating roller device 100 according to the present disclosure is preferably fastened on the roof 12 of a vehicle 10, in particular of a rail vehicle. The vehicle 10 has at least one first current collector frame 14 which is fastened on the roof 12 of the vehicle 10 and at the same time can serve as a current collector of the energy supply of the vehicle 10, but also as a holder for the lubrication roller device 100. In this case, the lubrication roller device 100 would be fastened on the current collector frame 14 spaced apart from and parallel to the contact strip 16.

In a preferred embodiment, a second, substantially equivalent current collector frame is fastened on the roof 12 of the vehicle 10 spaced apart from and in front of or behind the first current collector frame 14. The second current collector frame accordingly serves not for the energy supply of the vehicle 10, but exclusively as a holding device for the lubrication roller device 100.

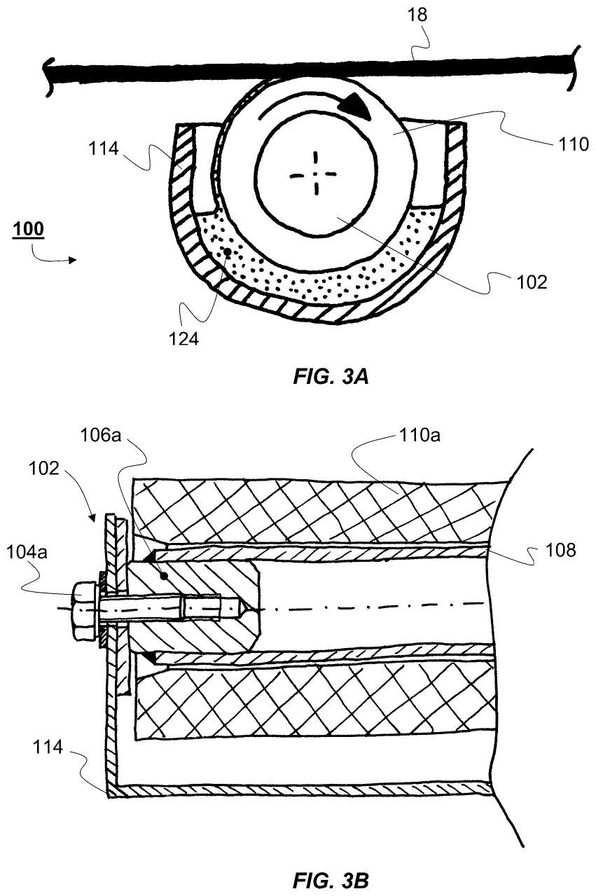

The lubrication roller device 100 is shown in FIGS. 3A-3B in a schematic sectional illustration (FIG. 3A) along the transverse plane parallel to the direction of travel, and (FIG. 3B) along the frontal plane orthogonal to the direction of travel. The lubrication roller device 100 is coupled in a functionally ready manner via a holder 102 or supporting device which is connected fixedly to the upper end of the current collector frame, and a transfer roller 110 is mounted on the holder 102 in a slidably rotatable manner.

In one embodiment of the present disclosure (see FIG. 3B), the transfer roller 110a is in the form of a hollow cylinder which is mounted in a slidably rotatable manner on a continuous axle or shaft 108. The axle or shaft 108 is preferably a hollow axle which is connected fixedly to an upper end of the current collector frame via suitable journals 106a, b and machine screws 104a, b. As a result, the weight of the construction and the resulting moments of mass and inertia are kept as low as possible and a possible circumferential bending of the axle 108 is avoided by the fixed connection to the current collector frame. Furthermore, the axle/shaft 108 and transfer roller 110a do not in each case have to be self-supporting, with the result that a lightweight construction is achieved. No press fit is required between the hollow axle and roller, and therefore rapid and uncomplicated replacement of the transfer roller 110a in the event of wear is ensured.

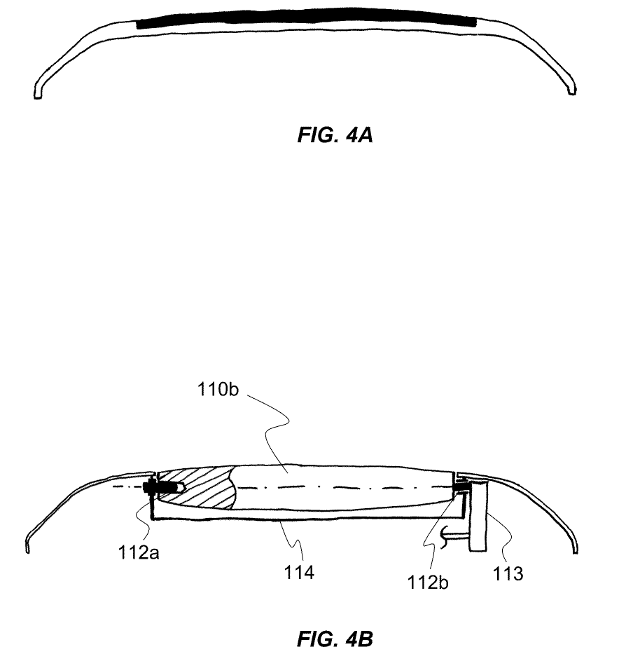

In an alternative embodiment of the present disclosure, the transfer roller 110b is in the form of a solid cylinder (see FIG. 4B) or hollow cylinder which is mounted in a slidably rotatable manner on two suitable bearing mandrels or journals 112a. The bearing mandrels or journals 112a are in each case connected fixedly to a corresponding upper end of the current collector frame and form a plain bearing with corresponding axially centrally oriented cavities of the transfer roller 110b. further alternative embodiment provides a shaft, a shaft stub 112b or two shaft stubs which are connected fixedly to the transfer roller 110b and which enable the transfer roller 110b to be mounted in bearing bushes or rolling bearings. Furthermore, the shaft or a shaft stub 112b can serve to couple the transfer roller 110b to a drive 113 located outside the trough 114 or to a brake. In this embodiment, a movable seal is provided between the trough end wall 120a, b and the shaft or shaft stub. Preferably, the transfer roller 110b has a convexly spherical shape which is adapted to the contour of a conventional contact strip, with the result that the transfer roller 110b can slide over contact wires 18 on different vertical planes without problems (that is to say without becoming entangled) and without wear in the event of a contact wire transition or a contact wire intersection.

Furthermore, the transfer roller 110b is composed of a friction-advantageous material which is optimized tribologically for the interaction with the contact wire 18, that is to say the friction between the surfaces, which are in relative movement, of the transfer roller 110a, 110b and of the contact wire 18 is optimized in such a way that the transfer roller 110a, 110b interacts in a rolling-sliding manner with the contact wire 18 within a specific speed range of the vehicle 10. The tribologically optimized material is furthermore designed in such a way that the contact wire 18 causes minimal wear in the interaction with the transfer roller 110a, 110b. The tribologically optimized material contains one or more solid lubricant(s) which ensure self-lubrication of the sliding surfaces between the transfer roller 110a, 110b and the holder 102 (fixed shaft or hollow shaft 108, and fixed bearing journals 112a, b). Typical solid lubricants are, for example, graphite, molybdenum disulfide (MoS2), tungsten disulfide (WS2), graphene and polytetrafluoroethylene (PTFE), or else a combination of these substances. The use and effect of solid lubricants for plain bearings are generally known in the art and are therefore not explained further.

The tribologically optimized material is preferably a plastic, for example a plastic with a base matrix composed of fluorine-stabilized plastic (similar to “Teflon”) which is filled with a solid lubricant (for example graphite).

Alternatively, it is also possible to use metallic material with good sliding properties, such as, for example, brass, certain cast types or metals with a particularly abrasion-resistant coating (for example aluminium with a nikasil coating) or with applied sliding lacquers.

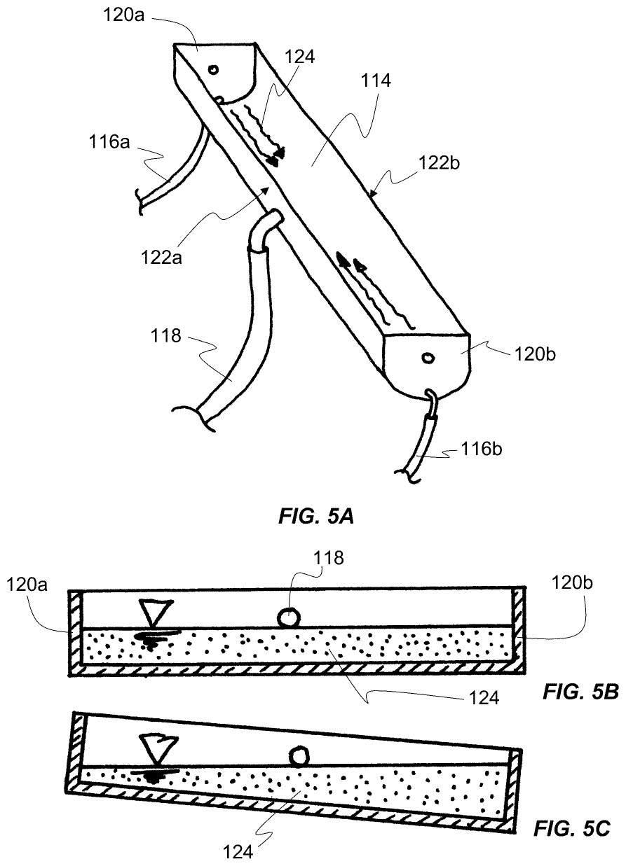

With reference to FIGS. 3A and 5A-C, a container 114 is preferably tub-shaped, coupled to the holder 102 and the upper end of the current collector frame. In an advantageous embodiment, the container 114 is arranged below the transfer roller 110a, 110b in such a way that a large part of the transfer roller 110a, 110b is functionally enclosed by the open container 114. In particular, the transfer roller 110a, 110b is embedded in the container 114 in such a way that the surrounding walls of the container 114 extend at least beyond the axis (shaft 108 or bearing journals 112a, b). In an alternative exemplary embodiment, the surrounding walls of the container 114 extend only to below the axis (shaft 108 or bearing journals 112a, b), wherein the container 114 is arranged in such a way that at least part of the transfer roller 110a, 110b can be functionally immersed in the antifreeze 124.

Two feed lines 116a, 116b are in each case attached to the axially opposite side walls 120a and 120b of the container 114 in such a way that antifreeze 124 can be fed into the container 114 simultaneously from both sides. The feed lines 116a, 116b are advantageously hydraulically balanced in order to achieve the same throughflow on both sides. An overflow 118 or outlet is attached to a front side wall 122a or rear side wall 122b, spaced apart from the container base, centered between the feed lines 116a, 116b. The overflow 118 determines the level of the antifreeze 124 passing through and also ensures that no change in the filling quantity occurs in the event of a transverse acceleration (for example cornering acceleration, centrifugal force) or an inclination of the vehicle 10 (for example elevated position of the track). A constant filling quantity of the antifreeze 124 should be used in order to keep the system weight and therefore the selected pressing force of the transfer roller 110a, 110b on the contact wire 18 constant. Furthermore, the free flow path of a lubricant flow is only half the container length, which in turn halves the resulting level difference which occurs on account of the relatively high viscosity of the antifreeze 124 with respect to water.

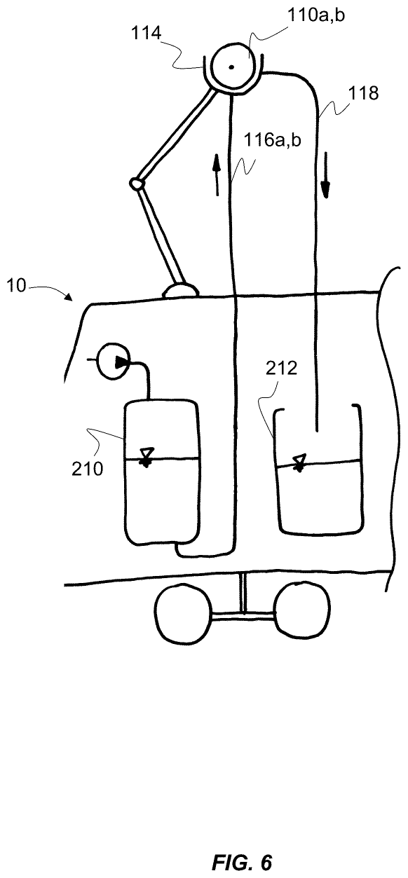

In one embodiment, the antifreeze 124 is pumped via a pump from a storage container 210 (see example in FIG. 6) via the feed lines 116a, 116b into the container (trough) 114 and discharged again via the overflow 118 or outlet attached to the desired level, with the result that the antifreeze 124 flows continuously through the container 114. In a further embodiment, the antifreeze 124 is conveyed via a storage container prestressed with compressed air, wherein it is therefore possible to dispense with the thick-matter pump which is otherwise required.

The example shown in FIG. 6 illustrates the supply with antifreeze 124 via separate storage container 210 and collection container 212. The collection container 212 can also be coupled, for example, to a vacuum generator in such a way that blockages in the outlet 118 are removed or the outlet 118 is flushed through regularly. As an alternative, the supply with antifreeze 124 can also be realized with only one storage container 210, wherein antifreeze 124 runs back into the storage container 210 in the vehicle 10 via a continuous circulation. Pump regulation is not required in this case and lubricant 124 is merely supplemented via the storage container 210 in the vehicle 10, or the empty storage container 210 is simply replaced with a full, less contaminated storage container 210. In order to avoid the occurrence of a contaminated return, the antifreeze 124 can also be supplied in lost operation. In such an embodiment, the container 114 is supplied with antifreeze 124, for example without a return (pure lost operation), wherein the level is regulated via a centrally attached level sensor or level switch and a correspondingly controlled pump/valve. In the case of inadequate quality of the level regulation, an additional overflow can also be provided as a fallback level in this case.

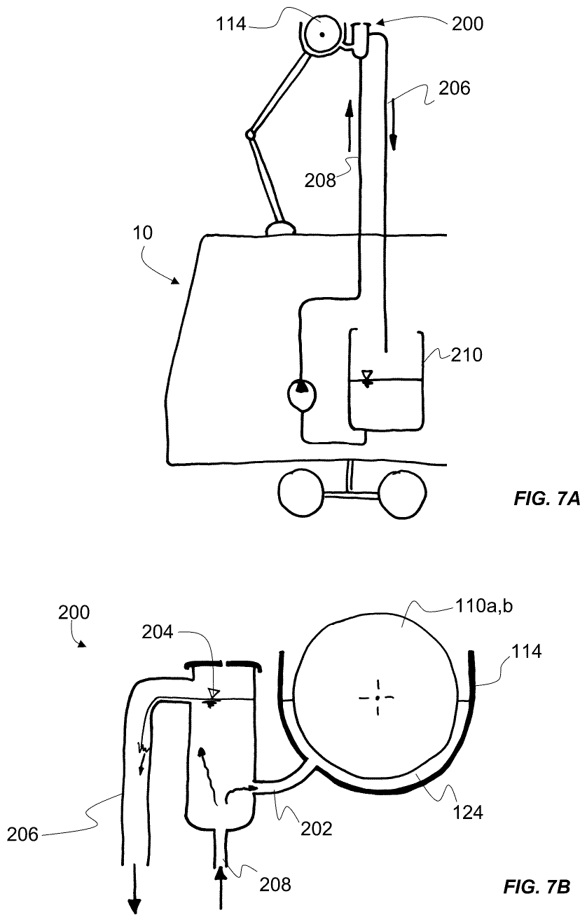

FIGS. 7A-7B illustrate a further embodiment for supplying the container 114 with antifreeze 124 without an overflow attached directly to the trough 114. In this case, the antifreeze is supplied from the storage container 210 via a feed unit 200 which is connected to the container 114 via a container inlet 202 attached centrally to the trough 114. The feed unit 200 enables a level 204 for lost operation without the use of sensors or any movable parts. In this case, the return of antifreeze 124 occurs via an outlet 206 departing from the level 204 of the feed unit 200 and fresh antifreeze 124 is supplied from below from the storage container 210 via an inlet 208 into the feed unit 200. The device 200 therefore prevents contaminants from passing from the container 114 into the return, with the result that the returning antifreeze 124 can be reused indefinitely. The feed unit 200 is attached centrally, analogously to the overflow 118 of the embodiment described above, in order that transverse accelerations do not lead to a change in the filling quantity of the trough or of the container 114.

During the operation of the lubrication roller device 100, antifreeze or lubricant 124 is transported and applied by the container 114 into contact with the contact wire 18 via fluid wetting of the smooth surface of the transfer roller 110a, 110b which is partially immersed in the antifreeze 124.

In the preferred embodiment, the transfer roller 110a, 110b is rotated (that is to say carried along) in a rolling-sliding manner by the contact wire 18. The transfer roller 110a, 110b is preferably driven at a predetermined rotational speed which is not directly proportional (that is to say the circumferential speed of the transfer roller is not equal to the travel speed) to the relative speed between the contact wire 18 and the vehicle 10. The rotation of the transfer roller 110a, 110b serves exclusively for conveying lubricant, with the result that relatively few revolutions per minute are sufficient to transport a desired amount of lubricant 124 from the prefilled container 114 to the contact wire 18.

A variation in the contact pressure between the contact wire 18 and the transfer roller 110a, 110b regulates the rotational speed of the transfer roller 110a, 110b (driven passively) and therefore the amount (lubricant film thickness) of the antifreeze 124 transported to the contact wire 18. The contact pressure between the contact wire 18 and the transfer roller 110a, 110b can be controlled via the current collector frame 14, for example via suitable adjustable spring systems, hydraulic or pneumatic cylinders (actuator) or a motor. In one embodiment, the contact pressure is regulated proportionally to the vehicle speed, for example via a supporting surface which generates lift or drive via the relative wind (or any other wind-dependent actuator) and which is functionally coupled to the current collector frame.

In another embodiment, the rotational speed is regulated, for example via a brake. The brake can be designed in the form of a viscous brake, a simple friction brake, a centrifugal brake or an electrodynamic brake which keeps the rotational speed of the transfer roller 110a, 110b relatively constant or at least below a predetermined maximum rotational speed. The brake is preferably functionally coupled to the transfer roller 110a, 110b via the holder 102. Viscous and centrifugal brakes, both electrodynamic brakes, are generally known and are therefore not explained further.

In a further exemplary embodiment, the transfer roller 110a, 110b is driven via a motor which actively controls the rotational speed and direction and therefore the delivery rate. In particular, the transfer roller 110a, 110b can be driven in the direction of the relative movement between the transfer roller 110a, 110b and the contact wire 18 (as in the case of the passive drive), but also in the opposite direction (counter to the relative movement), which possibly enables better adjustment of the delivery rate of the lubricant 124. Motor-driven rolls are known from the art and are therefore not explained in more detail here.

The present disclosure therefore provides means for controlling the rotational movement which limit the circumferential speed of the transfer roller to the effect that the transfer roller 110 rotates more slowly than in the case of sliding-free rolling along the contact wire. This is important in particular at relatively high speed, in order to prevent antifreeze 124 from being spun off, and can be achieved in particular by suitable control of the contact pressure, by means of a brake or by means of a motor.

In addition to the application of antifreeze, the device provided according to the present disclosure is also suitable for applying any other type of contact wire treatment agents. In particular, the following come into consideration as contact wire treatment agents: glycerol, glycol, oils, alcohol, salts or polymers, furthermore water-based antifreezes and agents with specific viscosity properties, for example thixotropic liquids and agents whose physical properties do not permit these to be sprayed or applied by means of impregnated brushes, felts, sponges or brushes.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGN LIST

10 vehicle
12 roof
14 current collector frame
16 contact strip
18 contact wire
100 lubricant device
102 holder
104a,b machine screw
106a,b bearing mandrel
108 shaft
110a,b transfer roller
112a,b bearing journals
113 drive
114 container
116a,b feed line
118 overflow
120a,b container sidewall
122a front container sidewall
122b rear container sidewall
124 lubricant, antifreeze, glycerol
200 feed unit
202 container inlet
204 level/level
206 outlet of feed unit
208 inlet in feed unit
210 storage container
212 collection container

1. A device for applying flowable antifreeze to a contact wire of an overhead line, from which an electrically driven vehicle draws off electrical energy via a current collector, the device comprising:
a holder, which extends from the vehicle in a direction of the contact wire;
a transfer roller, which: is oriented horizontally and transversely with respect to a vehicle longitudinal axis, is coupled to the holder in an axially rotatable manner, and is configured to be brought into contact with the contact wire; and
an open container for the antifreeze arranged below the transfer roller and partially enclosing a circumferential surface of the transfer roller in such a way that the transfer roller is configured to be wetted with the antifreeze supplied via the container via a rotational movement,
wherein the device is configured for controlling the rotational movement configured to limit a circumferential speed of the transfer roller to an effect that the transfer roller rotates more slowly than in a case of sliding-free rolling along the contact wire.

2. The device according to claim 1,
wherein a material of the transfer roller is optimized tribologically with the contact wire in such a way that the contact wire and the transfer roller, which in a state of relative movement, are configured to interact in a rolling-sliding manner with low wear within a predetermined contact pressure range, and
wherein the material is a plastic, a plastic with a base matrix composed of fluorine-stabilized plastic, which is filled with a solid lubricant, or a metallic material with good sliding properties, in particular brass, or a metal with an abrasion-resistant coating or an applied sliding lacquer, in particular aluminum with a nikasil coating.

3. The device according to claim 1, wherein a circumferential surface of the transfer roller is substantially convexly spherical.

4. The device according to claim 1, wherein the holder comprises a pretensioner configured to provide a predetermined contact pressure between the contact wire and the transfer roller.

5. The device according to claim 4, wherein the contact pressure between the contact wire and the transfer roller is configured to be varied selectively via the pretensioner.

6. The device according to claim 1, wherein the holder comprises a rigidly coupled holding element which forms a plain bearing with the transfer roller.

7. The device according to claim 1, wherein the container comprises at least one inlet, which is arranged at one axial end, for feeding, and an outlet, which is arranged centered between the mutually opposite axial ends on a side wall of the container, for discharging the antifreeze.

8. The device according to claim 7, wherein the container comprises two inlets which are attached to the mutually opposite axial ends of the container.

9. The device according to claim 7, wherein the outlet is attached at a predetermined distance from the container base.

10. The device according to claim 1, wherein the circumferential speed and/or the circumferential direction of the transfer roller is configured to be regulated independently of the vehicle speed.

11. The device according to claim 10, wherein the circumferential speed and/or the circumferential direction of the transfer roller is configured to be regulated via a motor driving the transfer roller.

12. The device according to claim 10, wherein the circumferential speed of the transfer roller is configured to be controlled via a brake coupled to the transfer roller.
